(19) United States
(12) Patent Application Publication
(10) Pub. No.: US 2026/0062214 A1
(43) Pub. Date: Mar. 5, 2026

(54) Warehouse for the storage and retrieval of goods or goods units arranged on load carriers

(71) Applicant: NEDCON B.V., Doetinchem (NL)

(72) Inventor: Calvin te Vaarwerk, Aalten (NL)

(73) Assignee: NEDCON B.V., Doetinchem (NL)

(21) Appl. No.: 19/313,979

(22) Filed: Aug. 29, 2025

(30) Foreign Application Priority Data
Sep. 2, 2024 (DE) 10 2024 125 017.8

(51) Int. Cl. B65G 1/04

(52) U.S. Cl. CPC B65G 1/0492

(57) ABSTRACT

A warehouse for storing and retrieving goods on load carriers includes racks with transport aisles along which a distribution vehicle can travel. Storage spaces are arranged to the sides of the transport aisles, and a connecting aisle intersects the transport aisles at crossing points. Both the transport aisles and the connecting aisle include guides with a running rail for the vehicle and side walls along the rail. At each junction of a transport aisle with a connecting aisle, four crossing points are defined. The junction is formed as an integral frame element fastened to a rack-mounted horizontal support surface in the region of the crossing points. The frame element is secured by connecting elements positioned laterally outside both the running rail and the plane of the side walls, thereby providing stable support while allowing uninterrupted travel of the distribution vehicle through the intersecting aisles.

### CROSS-REFERENCE TO RELATED APPLICATION

This application claims the benefit of German Patent Application DE 10 2024 125 017.8, filed on Sep. 2, 2024, the content of which is incorporated by reference in its entirety.

### TECHNICAL FIELD

The disclosure relates to a warehouse for the storage and retrieval, by means of a distribution vehicle, of goods or bundles of goods arranged on load carriers.

### BACKGROUND

Warehouses for the storage and retrieval of goods or bundles of goods arranged on load carriers by a distribution vehicle are also referred to as “shuttle warehouses.” The basic structure of the warehouse forms a rack which is constructed from a multiplicity of vertical and horizontal rack elements and in which the loading units, e.g., relatively large goods or pallets loaded with goods, are stored in individual storage spaces located on both sides of transport aisles. A distribution vehicle, often referred to as a “shuttle” or “satellite vehicle”, which can travel in the aisles is used to store, retrieve or transfer the goods within the warehouse. Said distribution vehicle is designed to move under the load carriers loaded with the goods and to lift them, or, by means of telescopic technology, to pull them laterally, and then to transport them to other positions within the warehouse. Such distribution vehicles operate autonomously and under program control and have means for lifting the respective load carriers fully automatically, for pulling them out of the laterally arranged storage positions into the aisle and then moving them within and along the transport aisles.

In the transport aisles, the distribution vehicle moves on rollers that run in rack-mounted guides, the guides being composed of a running rail, the horizontal upper side of which forms the running surface for the roller, and side walls. In order to enable the distribution vehicle to switch between individual transport aisles in larger warehouses, an additional connecting aisle can also be provided transversely to the transport aisles. This results in junctions of the connecting aisle with the transport aisles. Since the distribution vehicle rolls with its rollers along a left and a right guide, at each junction there are a total of four crossing points at which the guides converge in a cross-shaped manner.

These crossing points in particular usually result in the guides being greatly segmented in these regions, i.e. they are composed of shorter or longer rail segments following one another in the longitudinal direction. The mutually facing ends of the rail segments rest on a common horizontal support surface, for example on a rack-mounted bracket, and are screwed vertically thereon. The connecting elements, which are in the form of screws, even if the upper sides of these screws are recessed in relation to or are flush with the running surfaces, may lead to a slight vibration when driven over by the distribution vehicle, the vibration being associated with an increased generation of noise.

To reduce such a generation of noise, EP 3 321 216 A1 proposes the use of vertical press-fit threaded bolts as connecting elements instead of the otherwise usual countersunk head screws, wherein the press-fit threaded bolts used for this purpose are designed such that their upper surface ends flush with the running surface of the running rail, and it is thus possible to obtain a smooth and low-noise operation of the distribution vehicle. However, the use of correspondingly designed press-fit threaded bolts leads to higher parts costs compared to conventional screw connections.

Likewise, in order to reduce the generation of noise in the region of the butt joints between successive guides, DE 10 2010 029 563 B4 proposes that not all the butt joints, as seen in the running direction, are arranged at the same height, but that they are offset from one another. During its movement along the rail segments, the distribution vehicle does not simultaneously travel over the joints present on both sides. For the fastening of the guides or rail segments, use is made of screws with a substantially horizontal screw connection axis, and therefore the screws are located outside the running surfaces of the guides.

In the warehouse according to DE 10 2014 114 496 A1, rail segments, as seen in the rail longitudinal direction, each have, on the left and right next to the rail joint, a first receptacle for a bolt-shaped fastening means extending perpendicular to the rail longitudinal direction. A fastening bracket is also present. The latter has two U-shaped recesses for respectively receiving the fastening means, the U-shaped recesses being formed at an angle on the respective outer limb.

### SUMMARY

The disclosure is based on the object, in the case of a warehouse, in particular in the form of a shuttle warehouse, of reducing, in the region of crossing points of the junctions, noises and vibrations that would otherwise occur when driven over by the distribution vehicle (“shuttle”), making use of the advantage of low parts costs.

This object is achieved by the features of the independent claim. Expedient refinements and advantageous developments are specified in the dependent claims.

The warehouse has transport aisles which are located in a rack and along which the distribution vehicle can travel, having storage spaces or conveyor system transfer positions, which are located in the rack to the sides of the transport aisles, for the load carriers, and having a connecting aisle, along which the distribution vehicle can also travel and which intersects the transport aisles at crossing points, wherein components of the connecting aisle and the transport aisles are guides, which each have a running rail, along which the distribution vehicle can travel, and side walls along the running rail, wherein a junction of one of the transport aisles with one of the connecting aisles has four crossing points, wherein the junction is in the form of an integral frame element, which is fastened in the region of the crossing points on a rack-mounted horizontal support surface by means of connecting elements, wherein the connecting elements are each arranged laterally outside the running rail and laterally outside the plane in which the respective side wall extends.

It is now provided that the junction no longer consists of a plurality of individual parts, but of an integral frame element, which includes the guides and four crossing points. The frame element can then be fastened as one piece on one or more rack-mounted horizontal support surfaces by means of connecting elements. The integral frame element forming the junction preferably has a substantially square shape, with the crossing points being formed in the corners of the square shape. The crossing points of the integral frame element are connected to each other via the guides. This configuration makes it possible to substantially reduce the number of parts to be fitted in a warehouse rack and thus in the warehouse itself, which also leads to a reduction in the necessary installation time. In addition, necessary tolerances can be reduced by reducing the number of individual parts. Owing to the integral design, especially in the crossing points, it is also possible for the distribution vehicle to drive more evenly over them, and therefore shocks and vibrations can be avoided. This can reduce the generation of noise, which can also lead to reduced stress and reduced wear of the components and rack components involved and also of the distribution vehicle. This advantage has an effect particularly in the region of the crossing points of two aisles, along which the distribution vehicle is optionally drivable. During the course of operation, the region of the crossing points is particularly frequently driven over by the wheels or rollers of the distribution vehicle, which is why the continuous load is also particularly high in this region.

In the region of the crossing points, the junction, which is in the form of an integral frame element, is fastened on a rack-mounted support surface by means of connecting elements. Preferably, the frame element is fastened on a rack-mounted support surface at each crossing point by means of connecting elements. The support surface is preferably in each case a flat upper side of a stably designed plate. It is also crucial in this case that each connecting element is arranged laterally outside the running rail and laterally outside the plane in which the respective side wall extends, so that it does not cause any vibrations when the distribution vehicle drives past it.

Preferably, at each crossing point, four connecting elements are provided, via which the frame element can be fastened to the respective support surface. This enables a particularly secure and stable fastening of the frame element to the support surfaces.

It is particularly preferably provided that the connecting elements are used not only for fastening the frame element to the support surface, but that the connecting elements also at the same time form a guide for the distribution vehicles, when the latter are diverted at the junction from a transport aisle into a connecting aisle, or vice versa. The connecting means can then assist the cornering of the distribution vehicles. For this purpose, it can preferably be provided that the connecting elements can each have a curved outer surface which points in the direction of the crossing point, wherein, in the region of the crossing point, the curved outer surface can connect a side wall of a guide to a side wall of a guide extending transversely thereto. The curved outer surface preferably forms a rounded portion, in particular a convex rounded portion. For example, the curved outer surface can form a quarter circle.

In order to be able to achieve an as uninterrupted, form-fitting connection as possible between the guides, in particular the side walls of the guides, and the connecting elements, the connecting elements can each have at least one undercut for receiving an edge region of a side wall of a guide. The edge region of a side wall can then engage in the undercut, so that an as gap-free connection as possible of the side wall to the connecting element can be achieved. Preferably, each connecting element has two such undercuts. The undercuts preferably directly adjoin the curved outer surface of the connecting element, so that then the curved outer surface can be formed between two such undercuts. The undercuts can each be in the form of an elongate groove. The undercuts can be of such a length that they can accommodate the entire edge region of a side wall.

Laterally protruding tabs can be integrally formed on the frame element in the region of the crossing points. The respective connecting element can then engage in an opening or through-hole in the tab. The laterally protruding tabs can enable the fastening to be carried out away from the respective running rail of the guides. Preferably, at each corner of the crossing point, such a tab is formed on the frame element, and therefore four tabs can be formed on the frame part per crossing point.

The connecting elements can each have an underside. This underside enables the connecting elements, when mounted, to rest on the laterally protruding tab. In order, in addition to a force-fitting connection between the connecting element and the frame element or the tab of the frame element, also to be able to form a form-fitting connection, a contour for receiving the tab in a precisely fitting manner can be formed on the underside of the connecting element. The tab can then engage in the contour. The contour is preferably shaped in such a way that it forms a negative shape of the tab. The contour can be in the form of a recess on the underside of the connecting element. The contour can have a triangular shape.

In order to permit as rapid and simple a fastening as possible by means of the connecting elements, the connecting elements can each have a latching region for latchingly connecting the frame element to the support surface.

The latching region can have a latching pin which protrudes from the underside of the respective connecting element and which, when mounted, reaches through the opening or through-hole in the tab of the frame element and through an opening formed on the support surface and latches from behind against an underside of a plate having the support surface. The latching pin can have an elongate shape and can have a latching lug at a free end for gripping behind the underside of the plate. Preferably, the latching pin can be divided into two, so that preferably two symmetrically shaped parts form the latching pin. These two parts can be spaced apart from each other so that they can be springy relative to each other. During the assembly, these parts can be moved towards each other and thereby compressed so that they can be passed through the openings in the tab and through the opening in the support surface or the plate. As soon as the two parts engage in the openings, the parts can spring apart so that the latching tab of the latching pin, which is formed on both parts, can grip behind the underside of the plate.

Alternatively, it is also possible that the connecting elements do not have a latching region, but are fastened to the support surface by means of a screw connection for connecting the frame element.

The connecting elements can each have a basic body. The latching pin of the connecting element can then be integrally formed on the underside of the basic body. The basic body can then be that part of the connecting element which is arranged between two side walls arranged transversely to each other. By means of the basic body, the guide of the distribution vehicle can be substantially formed in the region of the crossing points. The basic body can be at least partially in the form of a hollow profile, with stiffening ribs being formed in the hollow profile. The design in the form of a hollow profile makes it possible to save on material. Despite the design in the form of a hollow profile, the stiffening ribs ensure that the basic body and thus the connecting element are very strong and stable. The stiffening ribs enable forces occurring when the distribution vehicles pass by to be absorbed.

The connecting elements can preferably each be made of a plastics material or a metal material. The connecting elements can then be produced, for example, in an injection-moulding process or 3D printer.

In order to further increase the stability and in particular the strength of the connection of the frame element to the support surface or the support surfaces, it can be provided that the frame element is fastened to the support surface with at least one screw connection in addition to the connecting elements.

For example, the frame element can be in the form of a punched and bent part. Furthermore, it is also possible that the frame element is cut out of a metal plate and bent to form the side walls.

In order to facilitate the installation of the junction in the form of an integral frame part in the rack, a positioning aid for aligning the frame element during installation can be formed on at least two opposite side walls of one or more of the guides. The positioning aid enables the frame element to be aligned using a measuring device, in particular a laser measuring device.

The positioning aid can be designed, for example, in the form of a recess on each of the side walls. The recess can be designed, for example, in the form of a slot or a notch. The positioning aid can therefore be introduced into the frame element even as the frame element is being cut or punched.

### BRIEF DESCRIPTION OF THE DRAWINGS

FIG. 1 shows a plan view of part of a warehouse for the storage and retrieval of goods or bundles of goods arranged on movable load carriers;

FIG. 2 shows an enlarged plan view of the junction marked by “II”in FIG. 1;

FIG. 3 shows a perspective illustration of the junction shown in FIG. 2;

FIG. 4 shows a perspective illustration of the crossing point marked by “III” in FIG. 2;

FIG. 5 shows a perspective illustration of the section marked by “IV”in FIG. 2;

FIG. 6 a perspective plan view from below of the crossing point marked by “V”in FIG. 5;

FIG. 7 shows a perspective illustration of the frame element of the junction shown in FIG. 1;

FIG. 8 shows the perspective illustration of a crossing point of the frame element;

FIG. 9 shows a perspective illustration of a connecting element in a plan view from above;

FIG. 10 shows a perspective illustration of the connecting element in a plan view from below;

FIG. 11 shows a further perspective illustration of the connecting element in a plan view from below;

FIG. 12 shows a perspective illustration of the connecting element rotated laterally; and

FIG. 13 shows a perspective illustration from below of a crossing point without a support surface.

### DETAILED DESCRIPTION

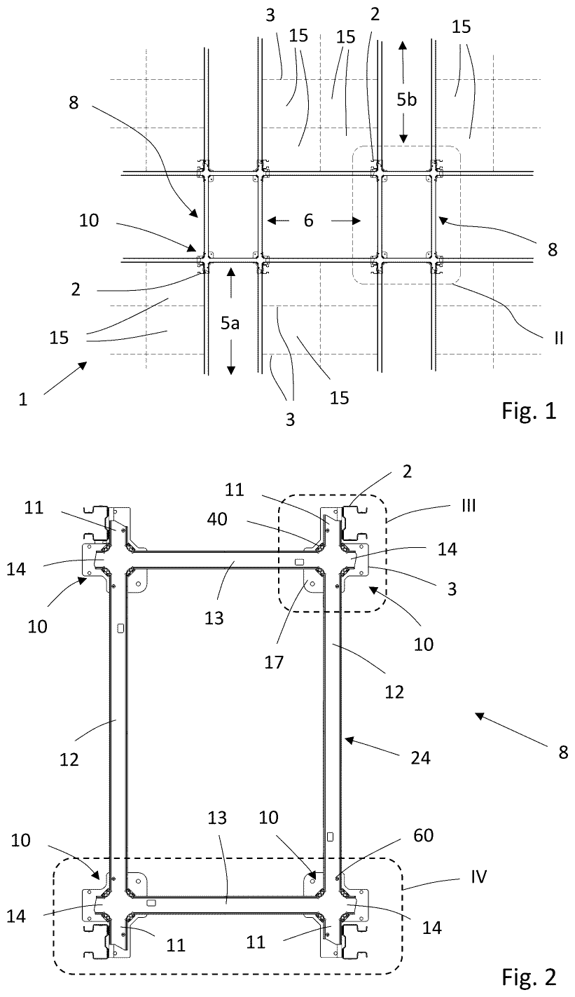

The static basic structure of the warehouse, which is only depicted in part in FIG. 1, forms a rack 1, which is composed of a multiplicity of vertical elements 2, in particular supports, horizontal elements each designed as a plate 3 and, optionally, reinforcing diagonal elements.

Within the extended rack 1, a motor-driven distribution vehicle, also referred to as a “shuttle”, is movable into various positions in order, from these positions, to store and retrieve goods located on standardized loading units, such as containers or cartons as load carriers. The distribution vehicle is designed to move under the load carriers loaded with the goods, then to lift or to pull them and then to transport them to another position within the warehouse. Such distribution vehicles operate autonomously and under program control. They run on at least three rollers and are guided laterally, with both taking place in rack-mounted guides that extend within the extended rack 1. The rollers of the distribution vehicle are preferably all driven.

For movement within the warehouse, there are a plurality of aisles therein, wherein FIG. 1 shows, in a section of the warehouse, two transport aisles 5a, 5b through which the distribution vehicle can travel. On both sides of the transport aisles 5a, 5b, individual storage spaces 15 or conveyor system transfer positions are located in the rack 1, so that load carriers deposited in said storage spaces 15 can be removed from this respective position by the distribution vehicle or stored at this position. The individual storage spaces 15 or conveyor system transfer positions are located on one or both sides of the transport aisles 5a, 5b and can therefore be served by the distribution vehicle positioned in the transport aisle 5a, 5b in front of the relevant storage space 15.

The transport aisles 5a, 5b are arranged parallel to each other. In order to enable the distribution vehicle to change between the aisles 5a, 5b, a transverse aisle is arranged in the rack 1 as a connecting aisle 6, along which the same distribution vehicle can also travel. This arrangement of the aisles 5a, 5b, 6 results in junctions 8 at which the distribution vehicle can not only drive straight ahead, but can also change its travel into the transverse direction.

Since such distribution vehicles usually have wheels or rollers on the left in the direction of travel and on the right in the direction of travel and therefore require a total of two driving lanes, and this is also true of the respective other aisle, i.e. transversely arranged aisle, a total of four crossing points 10 are in each case located at the junctions 8 of the transport aisles 5a, 5b with the connecting aisle 6. A crossing point 10 refers here to the location at which guides 11, 12, 13, 14 for the distribution vehicle meet at right angles. In the region of each crossing point 10, therefore, a total of four driving lanes formed by guides 11, 12, 13, 14 converge in a cross-shaped manner.

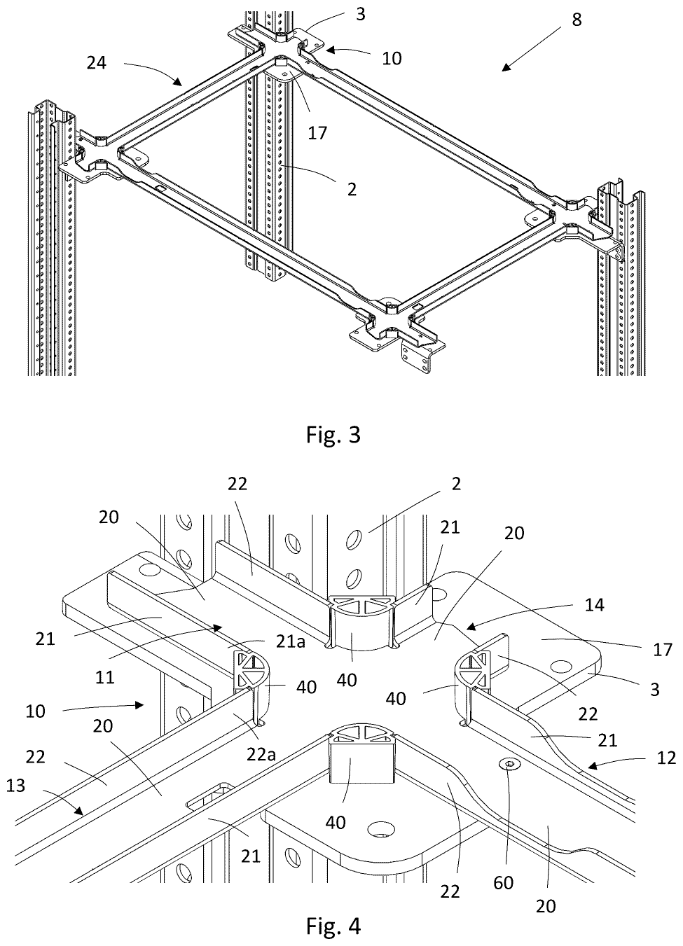

FIGS. 2 and 3 show, as an enlargement from FIG. 1, a complete junction 8 with the total of four crossing points 10, at which in each case four driving lanes, which are formed by guides 11, 12, 13, 14, for the wheels of the distribution vehicle converge in a cross-shaped manner. The junction 8 has an integral frame element 24, on which the guides 11, 12, 13, 14 and the crossing points 10 are formed together as one piece or one component.

In order, after its arrival at junction 8, to enable the distribution vehicle to continue to travel in a transverse direction, either its wheels or rollers, depending on the structure of the distribution vehicle, can change their rolling direction, or, however, the distribution vehicle is provided with two wheelsets, of which three or four rollers or wheels are used when travelling along the transport aisles 5a, 5b, and three or four other rollers or wheels are used when travelling along the connecting aisle 6. However, the running surface, and thus the plane, in which the wheels of the distribution vehicle roll, is always the same, i.e. the running surfaces on all the guides 11, 12, 13, 14 which come together at the crossing point 10 are at the same height and without any stepped transitions between them. Owing to the formation of the junction 8 as an integral frame element 24, the guides 11, 12, 13, 14 are connected integrally to one another, in particular in the region of the crossing points 10, such that there are no interruptions or steps in the region of the crossing points 10.

In the region of the crossing points 10, the frame element 24 is supported on a horizontal support surface 17 in each case. The support surface 17 in each case forms a flat upper surface of a horizontal plate 3, which is part of the rack 1, or is rigidly fastened to rack components.

FIG. 4 perspectively reproduces the region of one of the four crossing points 10 of the frame element 24, including the horizontal plate 3 forming the common support surface 17 and the four guides 11, 12, 13, 14, which are supported on the plate 3 and are used for the rolling and the lateral guidance of the respective wheels of the distribution vehicle. The guides 11 and 12 arranged successively in their longitudinal direction are components of the aisle 5b. The guides 13 and 14 arranged successively in their longitudinal direction are components of the crossing aisle 6. Owing to the integral design of the frame element 8, the guides 11, 12, 13, 14 in particular in the region of the crossing points 10, are formed integrally with each other.

Each guide 11, 12, 13, 14 is composed in turn integrally from a running rail 20, on which the wheels of the distribution vehicle roll, and upright side walls 21, 22 on both sides along the running rail 20. The side walls 21, 22 are preferably perpendicular to the running rail 20 in order thus to laterally guide the non-steered rollers or wheels of the distribution vehicle. The side walls 21, 22 can be formed integrally with the respective running rail 20. However, it is also possible that the side walls 21, 22 are each formed as separate parts, which can be mounted on the respective running rail 20. The running rails 20 of the guides 11, 12, 13, 14 are formed integrally with each other in the region of the crossing points 10.

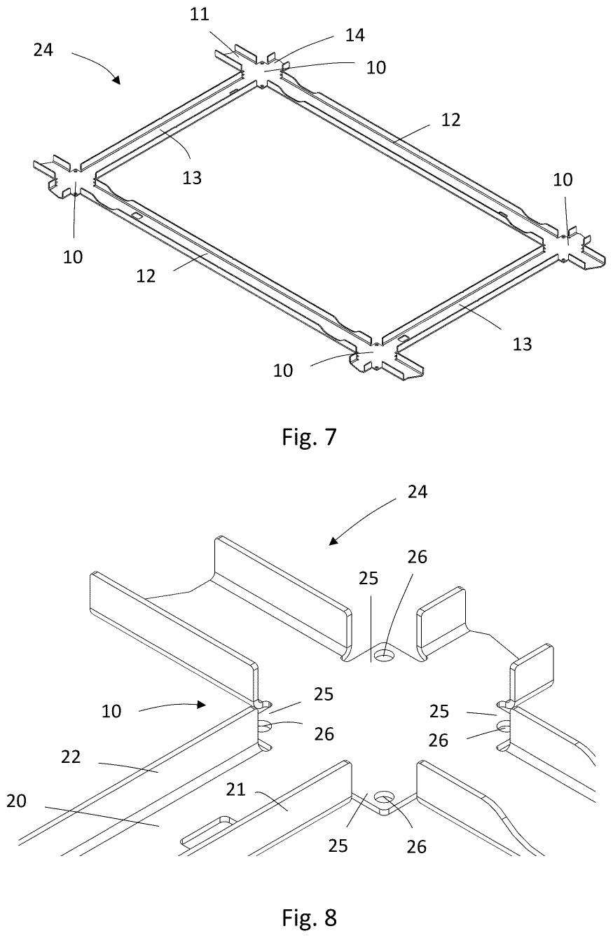

The side walls 21, 22 do not extend over the entire length of the guides 11, 12, 13, 14. On the contrary, the side walls 21, 22 are absent on the end sections of the guides 11, 12, 13, 14, that is, on those sections which face the next longitudinal guide 11, 12, 13, 14 in the longitudinal direction or which face the crossing point 10. The side walls 21, 22 of the individual guides 11, 12, 13, 14 are thus spaced apart from each other and do not collide with each other. This can also be seen once again in FIGS. 7 and 8, in which only the frame element 24 with the guides 11, 12, 13, 14 forming the frame element 24 can be seen.

In the region of the crossing points 10, the frame element 24 has laterally protruding tabs 25. In the refinement shown here, the frame element 24 has four such tabs 25 in the region of each crossing point 10. The tabs 25 extend in a plane with the running rails 20. When mounted, the tabs 25 thus rest flat on the support surface 17. The tabs 25 are specifically not covered by the side walls 21, 22; instead, the side walls 21, 22 end just before the tabs 25. The tabs 25 are each formed in a corner region of the crossing points 10. Each tab 25 has an opening 26 or through-hole. Via the tabs 25, the frame element 24 can be fastened to the support surface 17 and thus to the plate 3.

The frame element 24 is fastened to the support surface 17 via connecting elements 40. In the refinement shown here, as can be seen in particular in FIG. 4, four such connecting elements 40 are provided at each crossing point 10. The connecting elements 40 serve not only as a fastening of the frame element 24 to the support surfaces 17 or to the plate 3, but also as a guide for the distribution vehicles, in particular when they change the direction of travel at the crossing points 10.

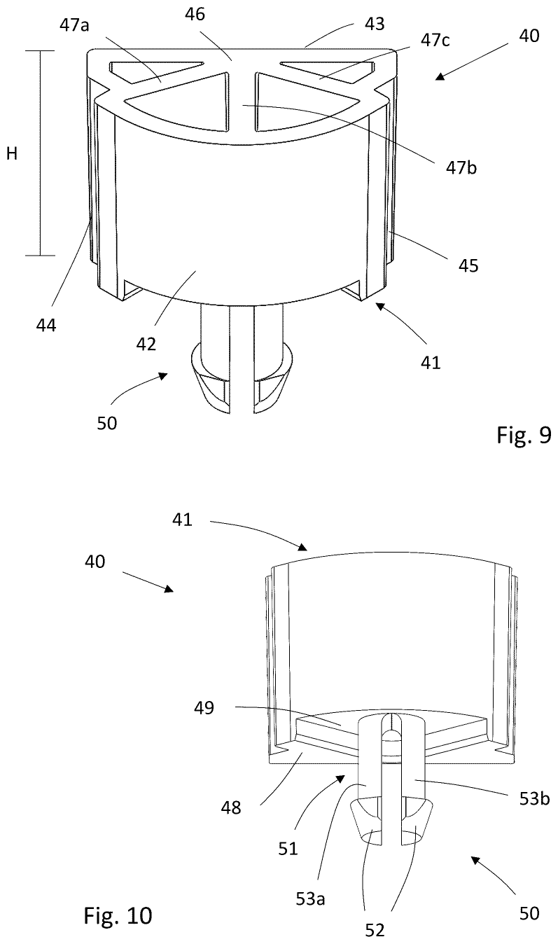

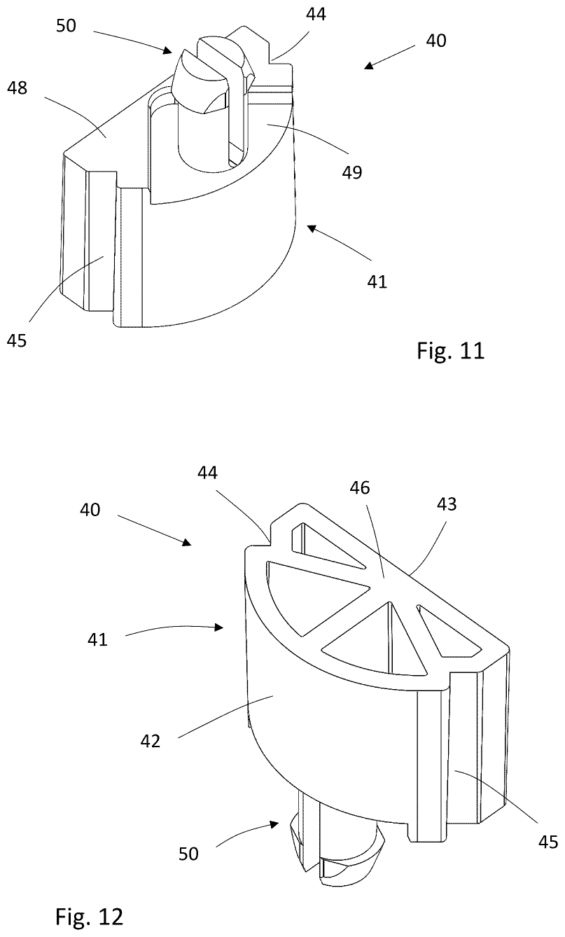

FIGS. 9 to 12 show a connecting element 40 illustrated by itself.

The connecting element 40 has a basic body 41. With the basic body 41, the connecting element 40 sits on the tab 25 of the frame element 24. In the refinement shown here, as can be seen in particular in FIG. 4, the basic body 41 has the same height H as the side walls 21, 22, so that the basic body 41 with its upper side 46 ends flush with the side walls 21, 22.

On its basic body 41, the connecting element 40 has a curved outer surface 42 pointing in the direction of the crossing point 10. By means of this curved outer surface 42, the connecting element 40 connects a side wall 21, 22 of a guide 11, 12, 13, 14 to a side wall 21, 22 of a guide 11, 12, 13, 14 extending transversely thereto, as can be seen in particular in FIG. 4. The curved outer surface 42 has a convex shape. The curved outer surface 42 approximately forms a quarter circle.

Furthermore, the basic body 41 has a straight outer surface 43 pointing away in the mounted state from the crossing point 10. The curved outer surface 42 and the straight outer surface 43 together form the outer circumferential surface of the basic body 41.

The connecting element 40 furthermore has two spaced-apart undercuts 44, 45 on its basic body 41. An edge region 21a, 22a of the side walls 21, 22 can be accommodated in a form-fitting manner in the undercuts 44, 45. As can be seen in FIG. 4, the edge region 21a of the side wall 21 can engage in the undercut 44 and the edge region 22a of the side wall 22 can engage in the undercut 45. The undercuts 44, 45 are each in the form of an elongate groove. The undercuts 44, 45 each extend over the entire height H of the basic body 41 of the connecting element 40. The undercuts 44, 45 are arranged on the basic body 41 in such a way that they are each arranged between the curved outer surface 42 and the straight outer surface 43. The curved outer surface 42 thus does not directly abut the straight outer surface 43, but the two outer surfaces 42, 43 are separated from each other by the undercuts 44, 45.

The side walls 21, 22 engage with their edge regions 21a, 22a in a form-fitting manner in the undercuts 44, 45 in such a way that an as gap-free connection as possible between the side walls 21, 22 and the connecting elements 40 is formed. Thus, disturbing edges or steps can be avoided in the curved region of a crossing point 10, so that the distribution vehicle can pass through the crossing points 10 with as little noise and vibration as possible.

The basic body 41 of the connecting element 40 is at least partially in the form of a hollow profile, as can be seen in a plan view of the upper side 46 of the basic body 41. Stiffening ribs 47a, 47b, 47c are formed in the hollow profile. The stiffening ribs 47a, 47b, 47c have a common starting point on the straight outer surfaces 43 and extend in a star-shaped manner away from this starting point on the straight outer surface 43 in the direction of the curved outer surface 42. The stiffening ribs 47a, 47b, 47c are in the form of projections. The stiffening ribs 47a, 47b, 47c allow the absorption of forces, for example, when the distribution vehicles collide with the connecting elements 40.

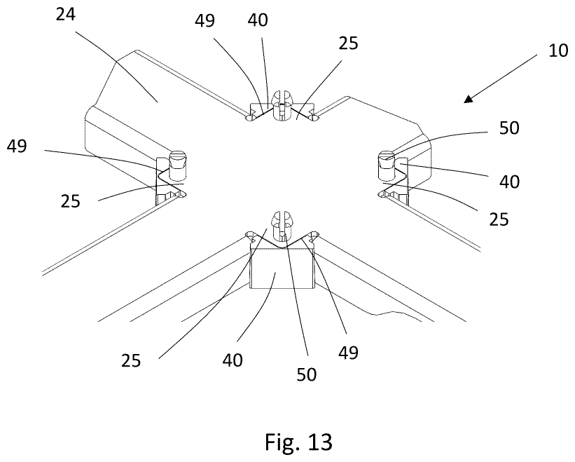

With an underside 48, opposite the upper side 46, of the connecting element 40 or of the basic body 41 of the connecting element 40, the connecting element 40 in the mounted state rests on the tab 25 of the frame element 24. In order to be able to achieve a form-fitting and thus particularly stable support of the connecting element 40 on the support surface 17, a contour 49 for receiving the tab 25 in a precisely fitting manner is formed on the underside 48 of the basic body 41, as can be seen in particular in FIGS. 10, 11 and 13. By means of this contour 49, in addition to a force-fitting connection between the connecting element 40 and the frame element 24 or the tab 25 of the frame element 24, a form-fitting connection can also be formed. The frame element 24 engages with its tab 25 in the contour 49, as can be seen in particular in FIG. 13. The contour 49 is shaped in such a way that it forms a negative shape of the tab 25. The contour 49 is in the form of a depression or recess on the underside 48 of the basic body 41 of the connecting element 40. In the refinement shown here, the contour 49 has a triangular shape.

By means of the connecting element 40, a latching connection can be formed between the frame element 24 and the support surface 17 of the plate 3. For this purpose, the connecting element has a latching region 50. The latching region 50 is integrally formed on the underside 48 of the basic body 41. The latching region 50 extends away from the underside 48. The latching region 50 is connected to the underside 48 in the region of the contour 49.

The latching region 50 has a latching pin 51 which protrudes from the underside 48 and, in the mounted state, dips through the opening 26 in the tab 25 of the frame element 24 and through an opening 18 formed on the support surface 17 of the plate 3 and latches from behind against an underside 19 of the plate 3, as can be seen, for example, in FIG. 6. The latching pin 51 has an elongate shape. At a free end of the latching pin 51, the latter has a latching lug 52 for gripping behind the underside 19 of the plate 3.

In the refinement shown here, the latching pin 51 is divided into two, so that two parts 53a, 53b shaped symmetrically to each other form the latching pin 51. These two parts 53a, 53b are spaced from each other so that a gap is formed between them, as a result of which they can move or be springy relative to each other. During the assembly, these parts 53a, 53b can be moved towards each other and are thereby compressed so that they can be passed through the openings 26 in the tab 25 and through the opening 18 in the plate 3. As soon as the two parts 53a, 53b engage in the openings 26, 18, the parts 53a, 53b can spring apart so that the latching lug 52, formed on the two parts 53a, 53b, of the latching pin 51 can grip behind the underside 18 of the plate 3. It is also possible that the latching pin 51 is formed not only from two parts 53a, 53b, but from three or more parts.

The connecting elements 40 are produced from a plastics material or a metal material, for example, in an injection-moulding process or in a 3D printing process.

The plate 3 is screwed directly to the adjacent, stable support 2 by means of a corresponding bracket. The plate 3 is of such an extent and extends so far below the respective crossing point 10 of the frame element 24 that the guides 11, 12, 13, 14 of the frame element 24 can also rest with a respective end portion of the running rails 20 on the support surface 17 of the plate 3. This dimensioning of the plate 3 or the support surface 17 with respect to the guides 11-14 or the frame element 24 ensures that there is no sagging of the guides 11-14 or of the frame element 24 on that longitudinal section on which the side wall 21, 22 ends and the laterally protruding tabs 25 are fitted.

The connecting elements 40 are arranged both laterally outside the respective running rail 20 and also laterally outside that plane in which the respective side wall 21, 22 extends.

In addition to the connecting elements 40, the frame element 24 is also secured to the plate 3 with screw connections 60, as can be seen in FIGS. 2, 4, 5 and 6. The screw connection 60 extends through the running rail 20 and the plate 3, in particular in the region of the guides 11, 12.

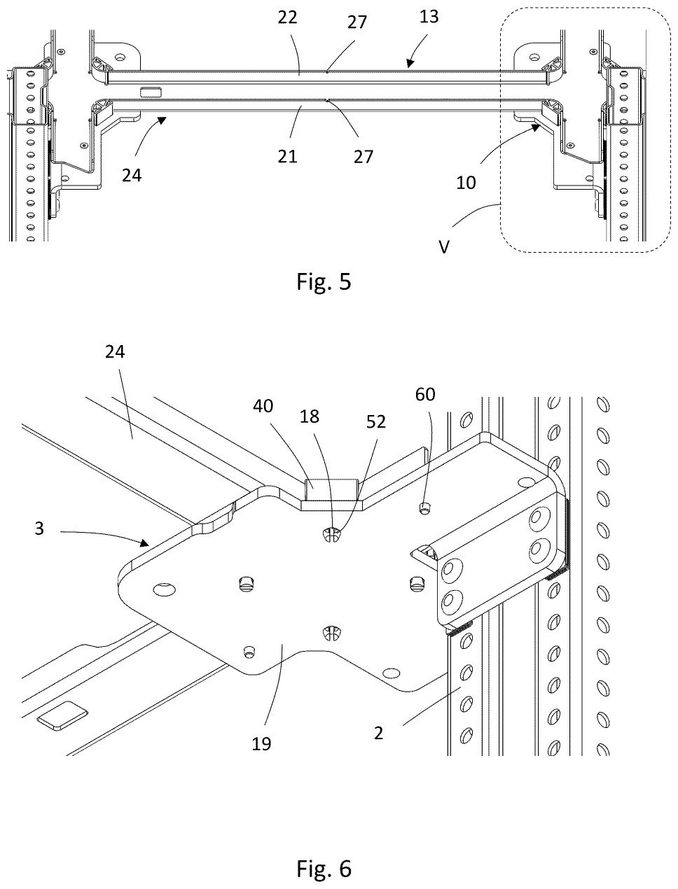

In order to facilitate the positioning and mounting of the frame element 24 on the plates 3, a positioning aid 27 is formed on at least two opposite side walls 21, 22 of one or more of the guides 11, 12, 13, 14, as can be seen, for example, in FIG. 5. The positioning aid 27 enables the frame element 24 to be aligned using a measuring device, in particular a laser measuring device.

The positioning aid 27 here is in each case in the form of a recess on the side walls 21, 22, the recess being in the form of a notch. The positioning aid 27 can be introduced into the frame element 24 as the frame element 24 is being cut or punched.

The frame element 24, which is formed from a metal material, can be produced in a punching and bending process or a laser cutting and bending process.

### LIST OF REFERENCE SIGNS

1 Rack
2 Vertical element, support
3 Plate
5a Aisle, transport aisle
5b Aisle, transport aisle
6 Aisle, connecting aisle
8 Junction
10 Crossing point
11 Guide
12 Guide
13 Guide
14 Guide
15 Storage space
17 Support surface
18 Opening
19 Underside
20 Running rail
20a Edge region
21 Side wall
21a Edge region
22 Side wall
24 Frame element
25 Tab
26 Opening
27 Positioning aid
40 Connecting element
41 Basic body
42 Curved outer surface
43 Straight outer surface
44 Undercut
45 Undercut
46 Upper side
47a, 47b, 47c Stiffening rib
48 Underside
49 Contour
50 Latching region
51 Latching pin
52 Latching tab
53a, 53b Part
60 Screw connection
H Height

What is claimed is:

1. A warehouse for storing and retrieving goods or bundles of goods arranged on load carriers by a distribution vehicle, the warehouse comprising:
transport aisles (5a, 5b),
wherein the transport aisles (5a, 5b) are located in a rack (1), and
wherein the distribution vehicle is configured to travel along the transport aisles (5a, 5b);
storage spaces (15) or conveyor system transfer positions,
wherein the storage spaces (15) or conveyor system transfer positions are located in the rack (1) to sides of the transport aisles (5a, 5b), for the load carriers; and
a connecting aisle (6),
wherein the distribution vehicle can also travel along the connecting aisle (6), and
wherein the connecting aisle (6) intersects the transport aisles (5a, 5b) at crossing points (10),
wherein components of the connecting aisle (6) and the transport aisles (5a, 5b) are guides (11, 12, 13, 14),
wherein the guides (11, 12, 13, 14) each have a running rail (20),
wherein the distribution vehicle is configured to travel along the running rail (20),
wherein the guides (11, 12, 13, 14) each have side walls (21, 22) along the running rail (20),
wherein a junction (8) of one of the transport aisles (5a, 5b) with the connecting aisle (6) has four crossing points (10),
wherein the junction (8) is an integral frame element (24),
wherein the integral frame element (24) is fastened in a region of the crossing points (10) on a rack-mounted horizontal support surface (17) by connecting elements (40),
wherein the connecting elements (40) are each arranged laterally outside the running rail (20) and laterally outside a plane in which a respective one of the side walls (21, 22) extends.

2. The warehouse according to claim 1,
wherein the connecting elements (40) each have a curved outer surface (42) pointing toward the crossing point (10) and, in the region of the crossing point (10), connects a side wall (21, 22) of a guide (11, 12, 13, 14) to a side wall (21, 22) of a guide (11, 12, 13, 14) extending transversely thereto.

3. The warehouse according to claim 1,
wherein the connecting elements (40) each have at least one undercut (44, 45) for receiving an edge region (21a, 22a) of a side wall (21, 22) of a guide (11, 12, 13, 14).

4. The warehouse according to claim 1,
wherein laterally protruding tabs (25) are integrally formed on the integral frame element (24) in the region of the crossing points (10), and wherein the respective connecting element (40) engages in an opening (26) or through-hole in the tab (25).

5. The warehouse according to claim 4,
wherein the respective connecting element (40) rests with an underside (48) on the laterally protruding tab (25), with a contour (49) for receiving the tab (25) in a precisely fitting manner being formed on the underside (48) of the connecting element (40).

6. The warehouse according to claim 5,
wherein the connecting elements (40) each have a latching region (50) for latchingly connecting the integral frame element (24) to the rack-mounted horizontal support surface (17).

7. The warehouse according to claim 6,
wherein the latching region (50) has a latching pin (51) which protrudes from an underside (48) of the respective connecting element (40) and which, when mounted, reaches through the opening (26) or through-hole in the tab (25) of the integral frame element (24) and through an opening (18) formed on the rack-mounted horizontal support surface (17) and latches from behind against an underside (19) of a plate (3) having the rack-mounted horizontal support surface (17).

8. The warehouse according to claim 1,
wherein the connecting elements (40) each have a basic body (41), which is at least partially a hollow profile, with stiffening ribs (47a, 47b, 47c) being formed in the hollow profile.

9. The warehouse according to claim 1,
wherein the connecting elements (40) are each made of a plastics material or a metal material.

10. The warehouse according to claim 1,
wherein the integral frame element (24) is fastened to the rack-mounted horizontal support surface (17) with at least one screw connection (60) in addition to the connecting elements (40).

11. The warehouse according to claim 1,
wherein the integral frame element (24) is cut out of a metal plate and bent to form the side walls (21, 22).

12. The warehouse according to claim 1,
wherein a positioning aid (27) for aligning the integral frame element (24) during installation is formed on at least two opposite side walls (21, 22).

13. The warehouse according to claim 12,
wherein the positioning aid (27) is designed in the form of a recess on each of the side walls (21, 22).
